(19) United States
(12) Patent Application Publication
(10) Pub. No.: US 2023/0001722 A1
(43) Pub. Date: Jan. 5, 2023

(54) Auxiliary tool for Stamping Stamp

(71) Applicant: Jian LIANG, Walnut, CA (US)

(72) Inventor: Jian LIANG, Walnut, CA (US)

(21) Appl. No.: 17/855,906

(22) Filed: Jul. 1, 2022

Related U.S. Application Data
(60) Provisional application No. 63/217,418, filed on Jul. 1, 2021.

(51) Int. Cl. B41K 1/00; B41K 1/36

(52) U.S. Cl. CPC B41K 1/003; B41K 1/36

(57) ABSTRACT

The utility model discloses an auxiliary tool for stamping stamps. The utility model is characterized by comprising a straight cube with evenly spaced positioning grooves on the front side. The grooves can assist the stamping stamp work to keep the printed texts neat and evenly spaced. The purpose of the utility model is to overcome the deficiencies in the prior art, and provide a simple structure, convenient work for stamping stamps, and making the stamped characters neat and beautiful.

### BACKGROUND OF THE PRESENT INVENTION

### Field of Invention

This utility model relates to an auxiliary tool for stamping stamp work.

### Description of Related Arts

Stamping stamps are widely used in machinery and equipment production information nameplates, jewelry, leather goods and other industries. Existing stamping stamp tools generally rely on visual alignment, and cannot ensure that the stamped text is neat and beautiful, and the text is not easy to align during work and is in operation. It is difficult to modify, so many stamped stamps on the market are not neat and unsightly, which greatly affects the work efficiency and quality of users.

### SUMMARY OF THE PRESENT INVENTION

The purpose of the utility model is to overcome the deficiencies in the prior art, and to provide a stamping stamp work auxiliary tool with simple structure, less cost, and convenience and ease of use.

In order to achieve the above-mentioned purpose, the present utility model adopts the following scheme:

An auxiliary tool for stamping stamp work, which is characterized by a straight cube with a positioning groove with a uniform distance on the front side, and this groove can assist the stamping stamp work to keep the printed text content neat and uniform. The purpose of the utility model is to overcome the deficiencies in the prior art, and provide a simple structure, convenient work for stamping stamps, and making the stamped characters neat and beautiful.

An auxiliary tool for stamping stamp work as described above is characterized in that a row of at least 2 equidistant grooves is provided on the subject, and this groove is connected to the raised structure of the stamping stamp or its auxiliary components It is consistent with each other, so as to achieve the function of setting the stamping stamp, and positioning the stamping seal in the card slot, thereby achieving the effect of determining the content of the stamping stamp.

The pitch of the grooves will have a variety of sizes to meet most work requirements.

In summary, the beneficial effects of the present utility model relative to the prior art are:

In the present utility model, equidistant positioning grooves are provided on the main body, and a single finger can easily fix the stamping stamp or its parts in the groove to complete the positioning work, allowing the stamping stamp tool to easily complete different Spacing the text content, and keep the text neat, improve the quality and efficiency of the work.

### BRIEF DESCRIPTION OF THE DRAWINGS

FIG. 1 is a schematic diagram of an auxiliary tool for stamping stamp work according to a preferred embodiment of the present invention.

FIG. 2 is another schematic diagram of an auxiliary tool for stamping stamp work according to the preferred embodiment of the present invention.

FIG. 3 is a schematic diagram of the the auxiliary tool in use.

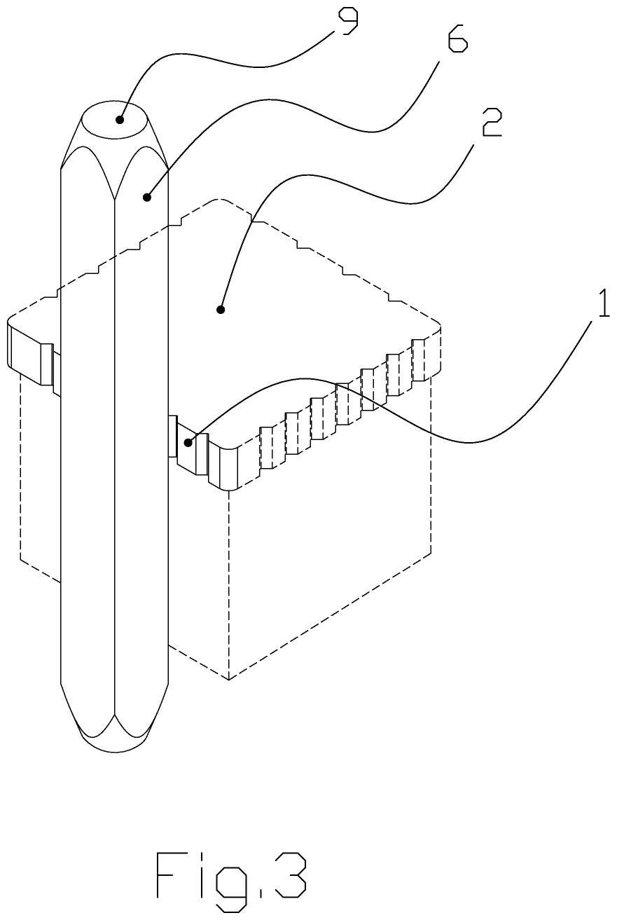

FIG. 4 is another schematic diagram of the utility model in use.

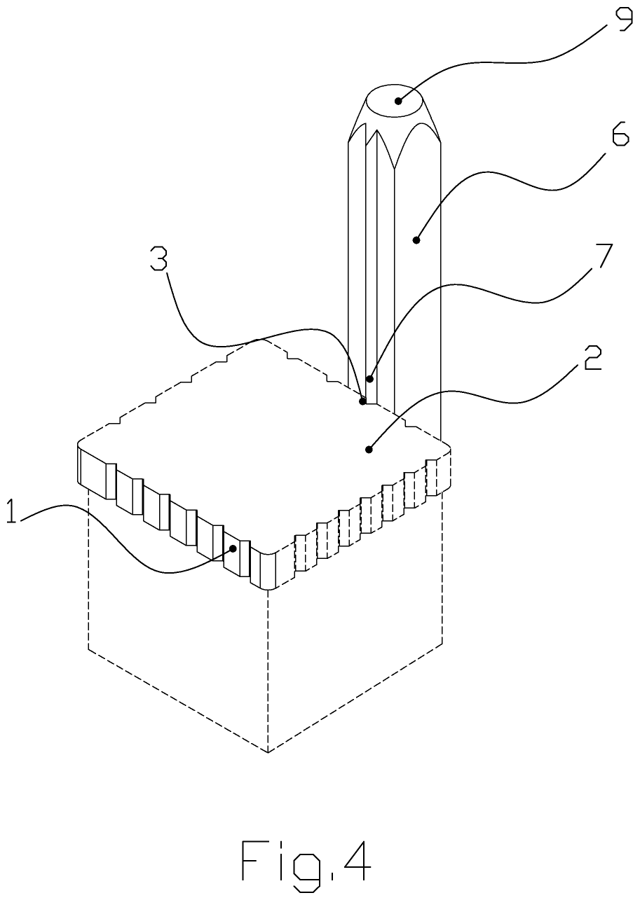

### DETAILED DESCRIPTIONS OF THE PRESENT INVENTION

The purpose of the utility model is to overcome the deficiencies in the prior art, and to provide a stamping stamp work auxiliary tool with simple structure, less cost, and convenience and ease of use.

In order to achieve the above-mentioned purpose, the present utility model adopts the following scheme:

An auxiliary tool for stamping stamp work, which is characterized by a straight cube with a positioning groove with a uniform distance on the front side, and this groove can assist the stamping stamp work to keep the printed text content neat and uniform. The purpose of the utility model is to overcome the deficiencies in the prior art, and provide a simple structure, convenient work for stamping stamps, and making the stamped characters neat and beautiful.

An auxiliary tool for stamping stamp work as described above is characterized in that a row of at least 2 equidistant grooves is provided on the subject, and this groove is connected to the raised structure of the stamping stamp or its auxiliary components It is consistent with each other, so as to achieve the function of setting the stamping stamp, and positioning the stamping seal in the card slot, thereby achieving the effect of forming the content of the stamping stamp on a working surface of an external object.

The pitch of the grooves will have a variety of sizes to meet most work requirements.

In summary, the beneficial effects of the present utility model relative to the prior art are:

In the present utility model, equidistant positioning grooves are provided on the main body, and a single finger can easily fix the stamping stamp or its parts in the groove to complete the positioning work, allowing the stamping stamp tool to easily complete different Spacing the text content, and keep the text neat, improve the quality and efficiency of the work.

Detailed Ways

An auxiliary tool for stamping stamps as shown in the figure includes a straight cube 2 with positioning grooves 1 with uniform distances on the front side. This groove can assist in keeping the printed text tidy during stamping stamp work. Uniform distance, stamping seal fixing auxiliary part 5, stamping stamp fixing auxiliary part convex structure 4, utility model stamping stamp unit 6, utility model stamping stamp unit convex structure 7, utility model stamping stamp unit impact bearing point 9, this utility model. The purpose is to overcome the shortcomings in the prior art, and provide a simple structure, convenient work for stamping stamps, and making the stamped characters neat and beautiful.

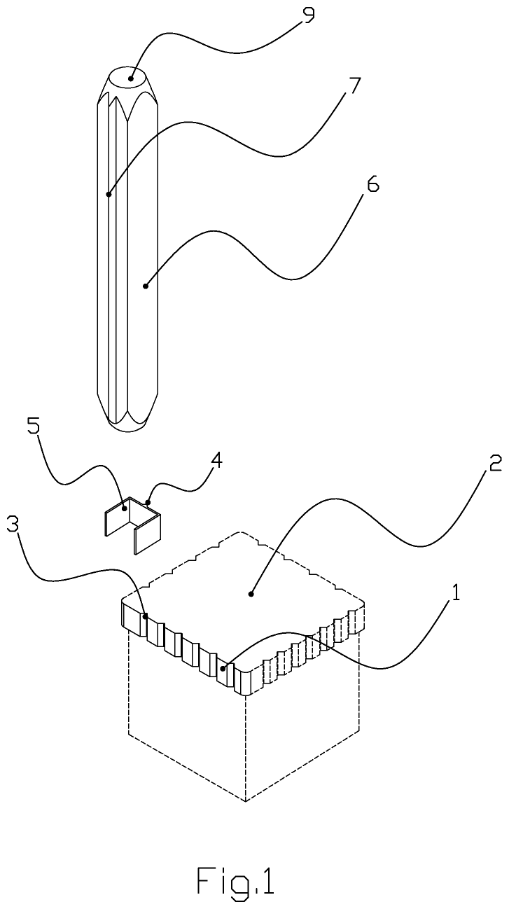

FIG. 1 is a schematic diagram of the auxiliary tool for the stamping stamps which may include a main body 1, a card slot 2, a card slot recessed structure 3, an auxiliary component 5, an auxiliary component protruding structure 4, a stamping stamp unit 6, a stamping stamp unit protruding structure 7, and an impact bearing point 9.

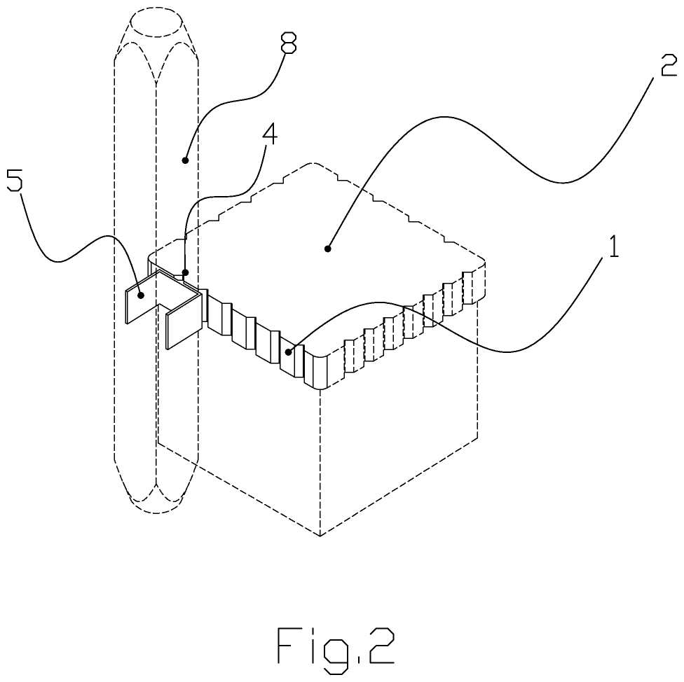

FIG. 2 is another schematic diagram of the of the auxiliary tool for the stamping stamps which may include a main body 1, a card slot 2, a card slot recessed structure 3, a stamping stamp unit working auxiliary component 5, a stamping stamp unit working with an auxiliary component protruding structure 4, a stamping stamp unit 6, a stamping stamp unit protruding structure 7, and a stamping stamp unit 8.

What is claimed is:

1. An auxiliary tool for stamping stamp work, comprising:
a main body having at least two positioning grooves formed on at least a front side thereof, wherein a stamping stamp is adapted to engage with at least one of said positioning grooves so that a user is able to impart impact on said stamping stamp as guided by said corresponding positioning groove so as to form a printed text on a working surface of an external object.
